(19) United States
(12) Patent Application Publication
(10) Pub. No.: US 2021/0394283 A1
(43) Pub. Date: Dec. 23, 2021

(54) SPHERICAL CUTTING TOOL, SYSTEM AND METHOD OF USING

(71) Applicant: David Giles, Clinton, MI (US)

(72) Inventor: David Giles, Clinton, MI (US)

(21) Appl. No.: 17/351,497

(22) Filed: Jun. 18, 2021

Related U.S. Application Data
(60) Provisional application No. 63/040,958, filed on Jun. 18, 2020.

(51) Int. Cl. B23C 5/02

(52) U.S. Cl. CPC B23C 5/02

(57) ABSTRACT

The spherical cutting tool and method of using the same are centered in the novel integration of a sphere cutter, with a roller burnisher tool, which may be adjustable, and may further be contained in a system comprising several additional components such as an indexer and a lathe, mill, or custom machine. The tool of the invention may further comprise a drill, end mill, reamer, or other similar cutting tool on one end, with the sphere cutter and roller burnisher. The method of the invention is comprised of steps for using the tool and system of the invention in a novel way, including steps for manipulating and actuating the novel spherical cutting tool to engage the inner or outer surface(s) of a workpiece, using multiple cutting operations on a fixed or movable indexer, or machining using the tool, system, and methods of the invention. The system of the invention utilizes at least two machine drive units, such as a lathes or other rotary machines, in conjunctions with an indexer, to be configured as a system for pre-drilling, drilling, reaming, and cutting. The system may be configured as a system for spherical cutting and hole finishing using the tool of the invention.

### CROSS-REFERENCE TO RELATED APPLICATIONS

This application claims priority to U.S. Provisional Application No. 63/040,958, filed on Jun. 18, 2020, which is incorporated herein by reference in its entirety

### BACKGROUND

Cutting tools are used in a variety of industries, including, but not limited to metal-working. To machine certain complex geometries, unique tool designs are often required. This is especially true considering the evolving complexities of parts and components, the combination of materials, and other factors. The invention can be used to machine complex geometries in order to improve feasibility and efficiency of machining and production processes.

### BRIEF DESCRIPTION OF DRAWINGS

FIG. 1 is a side perspective view of the apparatus of the invention showing an embodiment of the integrated spherical cutting tool, including a roller burnisher and sphere cutter.

FIG. 2 is a rear perspective view of the apparatus of the invention showing an embodiment of the integrated spherical cutting tool, including the axial and radial connection to an arbor in the clamped position.

FIG. 3 is a side perspective view of the apparatus of the invention showing an embodiment of the integrated spherical cutting tool, including the axial and radial connection to an arbor in an un-clamped position.

FIG. 4 is a rear perspective view of the apparatus of the invention showing an embodiment of the integrated spherical cutting tool, including an arbor disconnected from the integrated spherical cutting tool.

FIG. 5 is a side section view of the apparatus of the invention showing an embodiment of the integrated spherical cutting tool, including the axial and radial connection to an arbor in the clamped position.

FIG. 6 is a front perspective view of an embodiment of an end-cutting tool of the integrated spherical cutting tool, including cutting edges and inserts.

FIG. 7 is a side perspective view of the apparatus of the invention showing an embodiment of the integrated spherical cutting tool, including a roller burnisher, end-cutting tool, and sphere cutter.

FIG. 8 is a top perspective view of an embodiment of the system of the invention.

FIG. 9 is a side perspective view of an embodiment of the system of the invention, showing a section view of an embodiment of a workpiece of the system of the invention.

FIG. 10 is a side perspective view of a section view of an embodiment of the system of the invention, showing a section view of an embodiment of a workpiece of the system of the invention.

FIG. 11 is a side perspective view of a section view of an embodiment of the system of the invention, showing a section view of an embodiment of a workpiece of the system of the invention.

FIG. 12 is a side perspective view of a section view of an embodiment of the system of the invention, showing a section view of an embodiment of a workpiece of the system of the invention, showing an apparatus of the invention in a tool delivery mechanism of the system of the invention.

FIG. 13 is a side perspective view of a section view of a workpiece of the system of the invention, showing an apparatus on an arbor of a rotary machine of the system of the invention.

FIG. 14 is a side perspective view of a section view of an embodiment of the system of the invention, showing a section view of an embodiment of a workpiece of the system of the invention, showing an apparatus of the invention in a tool delivery mechanism of the system of the invention.

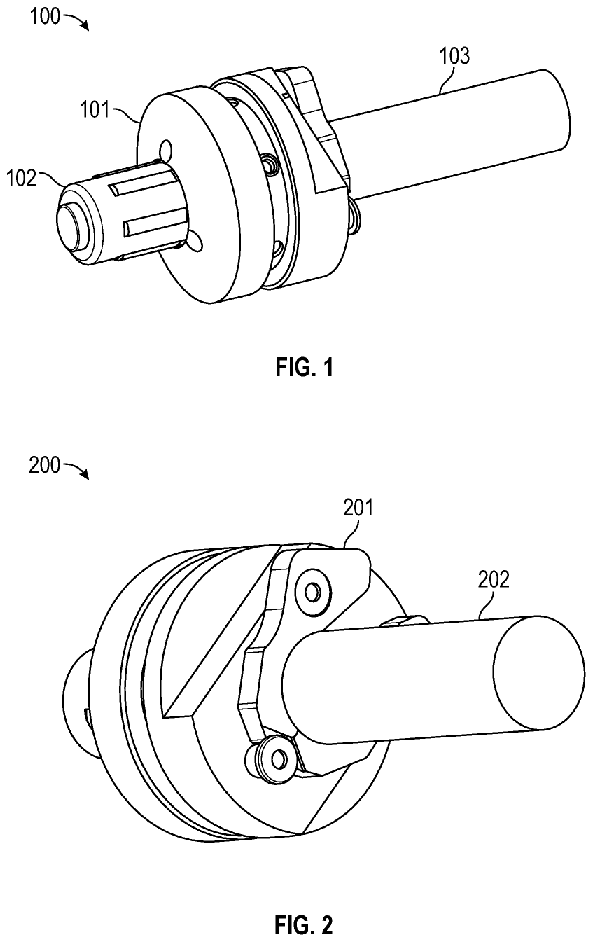

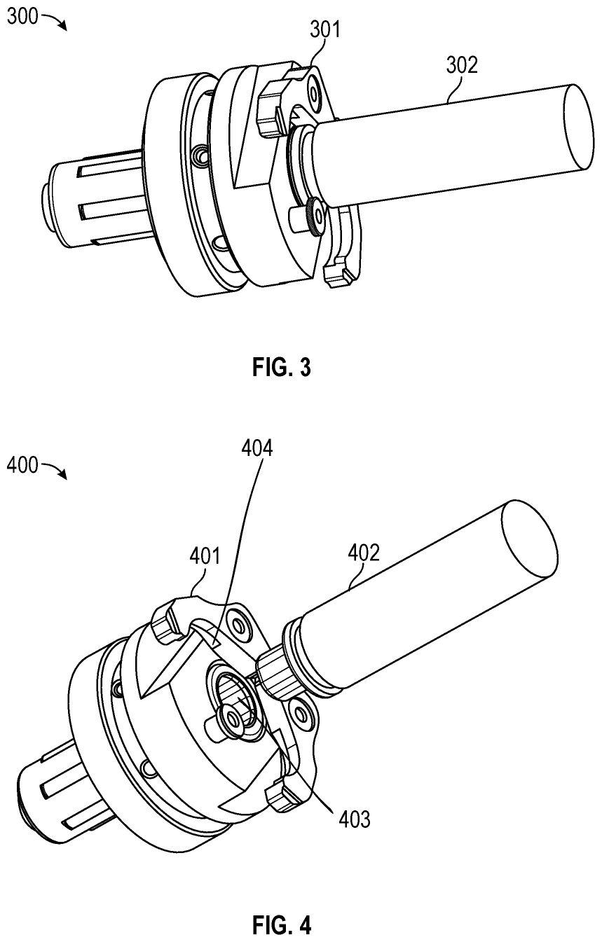

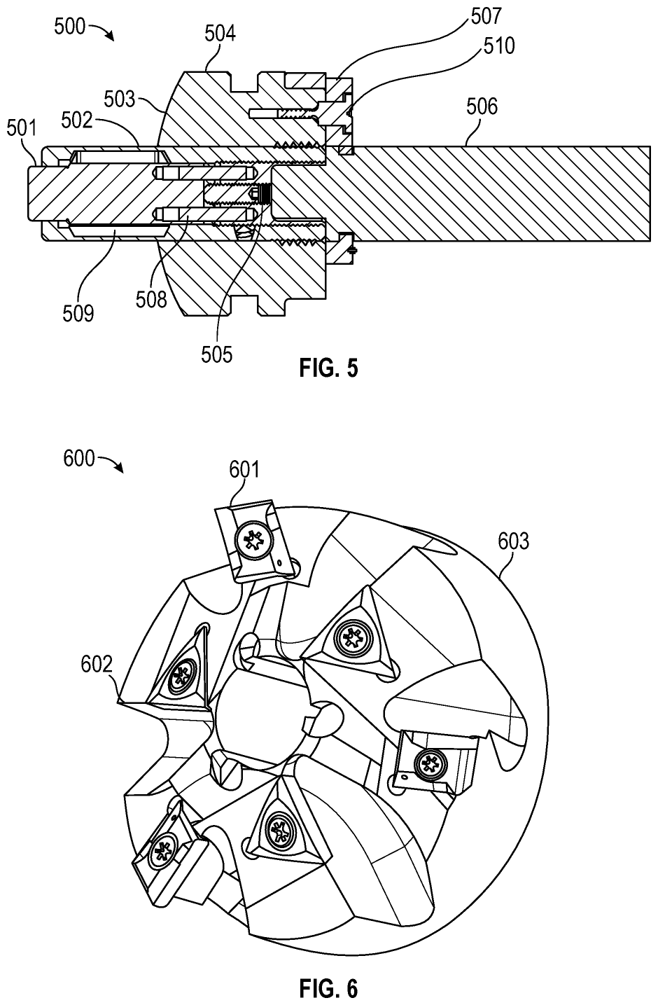

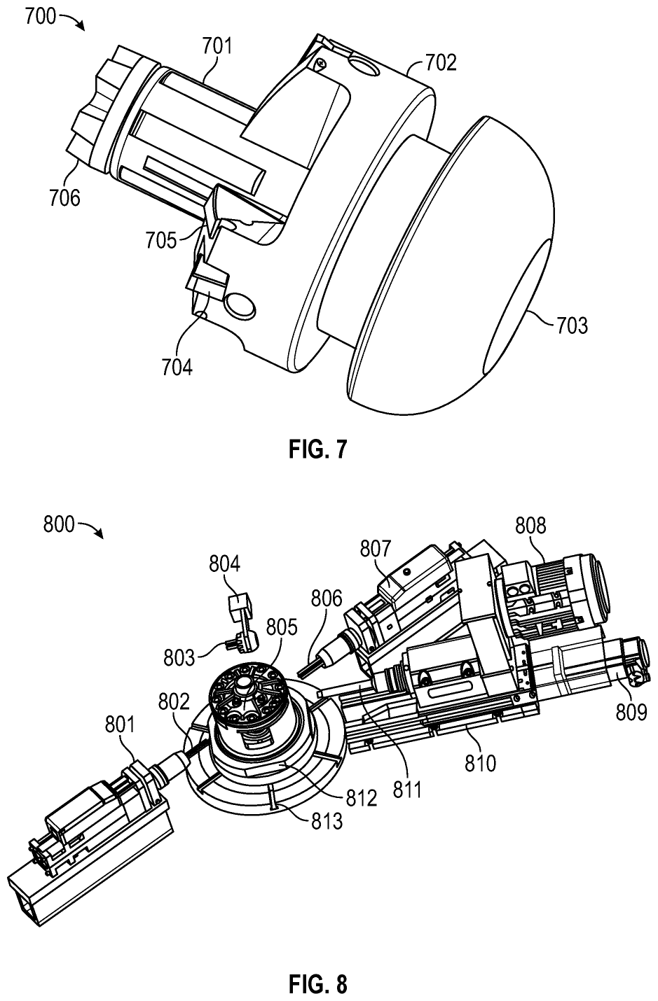

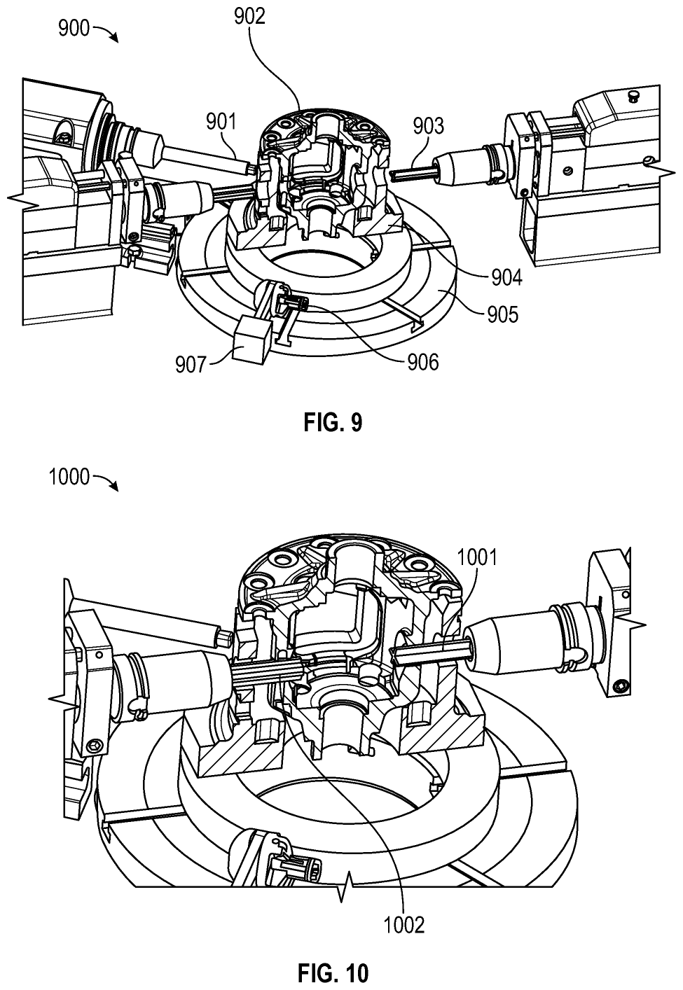

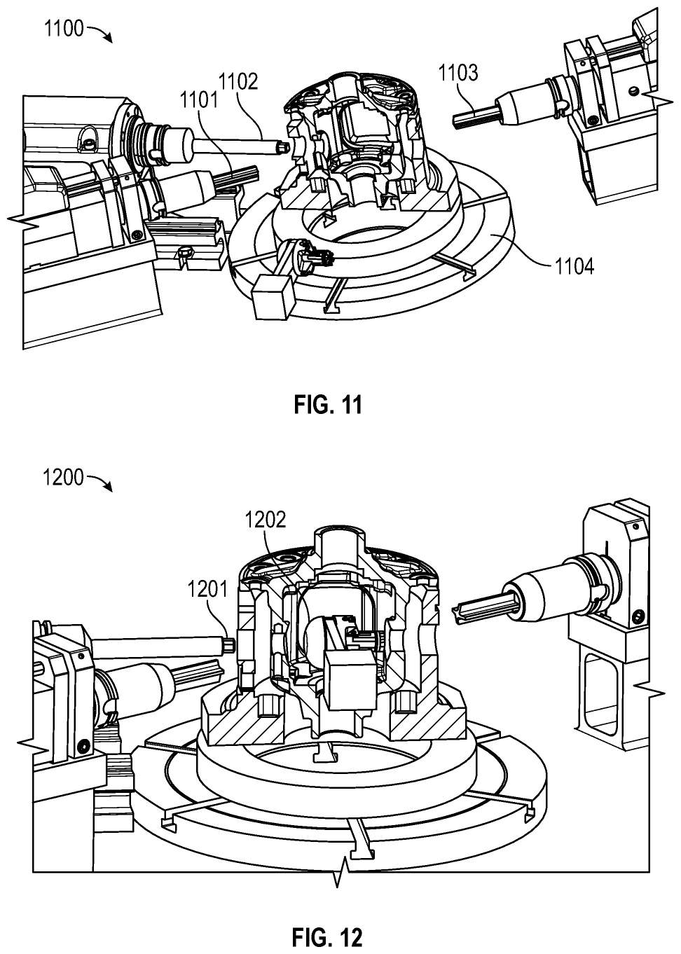

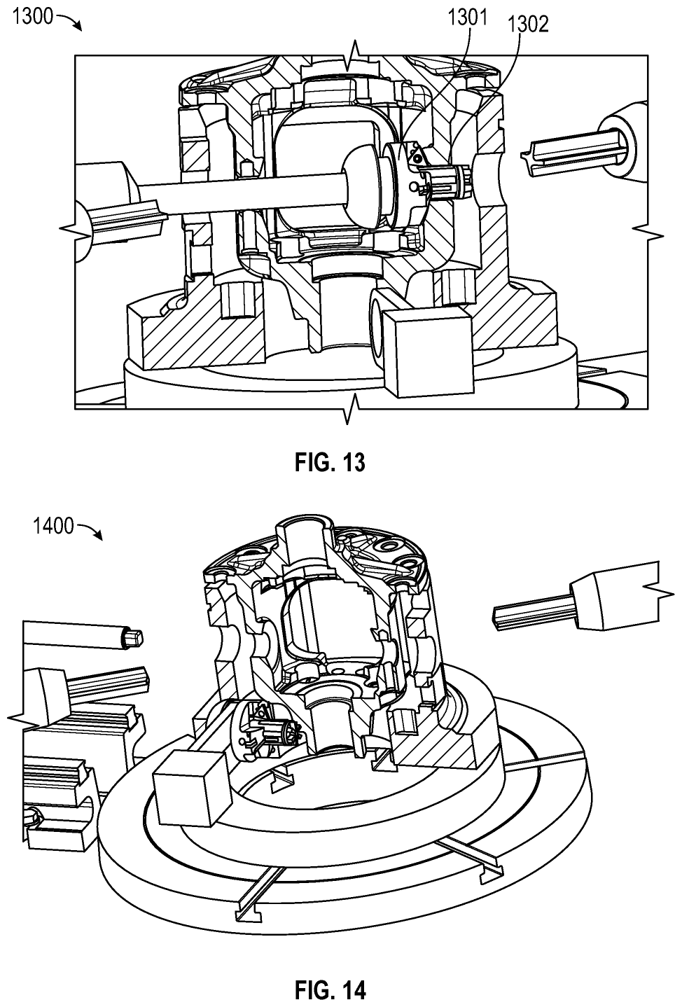

### DETAILED DESCRIPTION

This invention encompasses a new design for a novel spherical cutting tool integrated with a roller burnisher 100, as well as a first method for utilizing the tool to machine parts, the tool being configured to machine a part comprised of a metal material. Such parts machined by the invention may instead be comprised of a plastic, rubber, masonry, composite, ceramic, or other material. The tool of the invention may further comprise an end cutting tool 706 such as a drill, end-mill, reamer, dreamer, drill-mill, any combination thereof, or other similar cutting tool on at least one end, with the sphere cutter 101 and roller burnisher 102. A dreamer is a combination of a drill and a reamer. A drill-mill is a combination of a drill and an end-mill.

The spherical cutting tool of the invention comprises a drive connection 201, 301, 401 that is made up of two components—an axial component 404 and a radial component 403. The radial component is for purposes of rotationally driving the tool. The axial component may be intermittent such that it allows for engagement and disengagement with a drive arbor of a drive machine. The radial component of the drive connection may be triangular, hex, star, square, slot, or other drive fitting or means for connecting to and driving a tool known in the art of machining which is configured to connect to a spindle, arbor drive, gear drive, belt drive, or other rotary machine known in the art of machining.

The tool further may comprise a roller burnisher and a sphere cutter with cutting edges 602 on the cutter face 503, as part of the cutter body 504, cutting inserts 704, 705 (which may be braised or bonded in, or machined as part of the tool) or interchangeable cutting inserts 601, the burnisher having a size adjustment mechanism, which may be integrated or not integrated into the sphere cutting portion of the tool. The adjustment mechanism 505 may be configured to be operated by hand, by tool, or by automatic, self-adjusting means such that roller burnisher diameter automatically adjusts to a predetermined size, such as by using a spring and stroke limiter, or other automatic adjustment means.

The roller burnisher of an embodiment of an apparatus of the invention may be configured to have a burnisher housing 502 with rollers 509, a center taper roller 501 and slip fit anti rotation pins 508. Similarly, the burnisher housing may be configured to have a slip-fit relationship with the cutter body. Similarly, the sphere cutter body may be configured to have a slip fit with an arbor 506 and further may have a clamp element 507 which may be secured by spring force or by manual lock feature. The tool of the invention may further include a shoulder screw 510 used as a pivot pin.

The tool may further have a permanent or replaceable drill, endmill, reamer, or other cutting implement known in the art of machining.

All cutting aspects of the cutting tool are capable of being manipulated to disengage from the tool, such that the tool of the invention is capable of being disassembled into its constituent parts, for repair, replacement, resizing, customization, or as determined by a user.

In at least one embodiment, the tool of the invention has means for routing coolant or oil either that are integral to the tool or may be adjacent to the tool. This commonly known as “through the tool coolant” in the machine tool industry.

The connection means for attaching the tool to a spindle or other rotary machine are configured at only one end 703, opposite the roller burnisher 701, where the sphere cutter aspect of the tool is configured between the roller burnisher and means for attaching the tool to a spindle or other machine drive 702. When an end-cutting tool 706 is integrated into the tool, such as a drill or endmill, such end-cutting tool is configured at the distal end of the means for attaching the tool to a spindle or other machine drive. It may be permanent or removable from the spherical cutting tool.

In at least one embodiment of the spherical cutting tool, the cutting and forming elements—including the end-cutting tool, roller burnisher, and sphere cutting cutter—of the tool are coaxial about the axis of the spindle connection.

In one embodiment of the invention, the roller burnisher comprises rotating spherical balls, and in another embodiment of the invention, the roller burnisher comprises rotating rollers.

An embodiment of the invention may further include a system 800 of and method for using a tool such as the sphere cutting tool of the invention, the system comprising a cutting tool, a drive machine comprising a cutter motor 808, a cutter feed motor 809, a drive arbor slide 810, 901 and a cutter drive arbor 811, a fixture 812, 904 configured to hold a workpiece 805, 902 (potentially a differential case) on an indexer 813, 905 a mechanism 804, 907, whether human or machine, for changing tools 803, 906 on the drive machine, a compartment wherein cutting and drilling operations take place. A rotatory drive mechanism, such as a spindle on a lathe or mill, is configured in proximity to the indexer, is further configured to be operated by means of hydraulic power, mechanical power, electric power, air power, or other means known in the art of powering machines. The machine further includes means for oil or coolant dispersing in at least two directions or if said means are not interconnected with the drive machine, a second device for emitting oil or coolant is located opposite of said drive machine in proximity to the indexer with a nozzle directed toward the center of the indexer. The system may further have a second tool, wherewith said mechanism of the device configured to interchange the first tool with said second tool, the second being of the type commonly used in the machining industry, including but not limited to drills for rough cutting, finishing, fluid jets, or other tool types.

One embodiment of the system also includes one 807 or two 801 additional drill machines having tools for rough cutting 802, 806, 903 drills for finishing 802, 806, 903, or combination drill and reamers 802, 806, 903 (dreamers), fluid jets 802, 806, 903, or other tool types 802, 806, 903, said drill machines when more than one is used oriented in proximity to the indexer 180 degrees in position to one another with their axis' inline across the center of the rotating fixture and indexer about the 360-degree circumference of the indexer and the axis between those spindles at some fixed angle to the spherical cutter drive arbor and spindle axis. Spindle units, for the purpose of driving a variety of cutting tools, may also be mounted perpendicular to the sphere cutting axis of the machine for machining cross holes or features perpendicular to the center line of the machined sphere pocket.

The first tool of the system of the invention is contemplated to be the spherical cutting tool with integrated roller burnisher of the invention 803. In another embodiment, the first tool is contemplated to be the spherical cutting tool with integrated roller burnisher of the invention, including an end cutter at the distal end of the tool, opposite of the means for connecting driving the tool as herein described.

The drive machine of the system of the invention is contemplated to be a spherical cutting machine in at least one embodiment.

The method of using said system includes steps for mounting a workpiece to or in the indexer fixture, drilling or cutting a hole in a workpiece, rotating the indexer to a predetermined angular distance, inserting the first tool of the system—the spherical cutting toll with integrated roller burnisher, machining the workpiece with said first tool, withdrawing said first tool from the workpiece, and returning the indexer to a starting position.

One embodiment of the method of using the system of the invention, includes steps to machine holes in a workpiece, and machining spherical pockets precisely concentric with those holes by engaging the roller burnisher of the system into the pre-machined hole to keep the sphere cutter in precise concentric location with the hole as the spherical pocket is machined.

These steps consist of mounting a workpiece in or on a workpiece holding fixture mounted to the system's rotary indexer. Drilling rough or finished holes into the workpiece, at the location where the spherical pockets will be located, by means of drill unit/s located in proximity to the indexer 1001, 1002. Then rotating the indexer to allow the presentation of the (first tool) roller burnisher sphere cutter combination tool in locational relationship to the previously machined holes.

Using a tool delivery sub-system presenting the tool into the compartment of the workpiece such that in can be engaged by a drive arbor in-line with its axis of rotation and in-line with the previously drilled holes. Advancing said drive arbor through one previously machined hole such that it engages the combination tool (first tool), retracting the tool delivery/retrieval sub-system, rotating the drive arbor to cutting speed and advancing the drive arbor with the attached integrated spherical cutting tool 1301 such that the burnisher aligns in a previously machined hole 1302, that is in-line with the hole that the drive arbor is passing through, and the sphere cutter cuts a spherical pocket concentric to these hole. Retracting the drive arbor and the combination tool from the machining position, stopping and orienting the drive arbor and tool, advancing the tool delivery/retrieval sub-system to capture the combination tool, fully retracting the drive arbor out the workpiece compartment and fixture, retracting the tool delivery/retrieval sub-system with the tool attached 1202, rotating the fixture and workpiece and repeating as desired or necessary.

The process further includes steps for rotating the indexer, repeating the process as necessary for machining additional geometries, and concluding with removing the workpiece and returning the indexer to its predetermined machine starting position. Steps of the invention further include water/jet/oil washing said workpiece before, during, and after said step for cutting the workpiece using one or two water/jet/oil streams.

In another embodiment of the system of invention, the spherical cutting tool may be configured to be part of a double-sided tool.

In another embodiment of the integrated spherical cutting tool, the roller burnisher comprises rotating spherical balls.

In another embodiment of the system, the tool delivery mechanism may have at least one joint that allows the tool to be manipulated so as to fit a relatively larger tool through a smaller opening in a part by turning it on an angle as it passes through the opening, known as the transport or movement position, and this embodiment of the invention further has means for locking the tool geometry in the cutting position after passing it through the opening using the at least one joint. When in the manipulated position, the tool is configured to take on a second geometric shape and size. The tool may be locked in a fixed position, such as storage, transport, or cutting position.

In one step of one embodiment of the method of using the system and tool of the invention, the system having at least one joint is manipulated from a first position to a second position for transport or movement, taking a second geometric shape, is inserted into a workpiece, and manipulated to the first position to return all cutting elements to the coaxial position with the drive arbor and drive spindle.

The system of the invention may further comprise a gearbox that interfaces with a drive unit powered on a spindle or similar rotary machine, such that the tool gear box body is stationary with respect to the rotating spindle. Said gearbox of the system, known as an angle drive, is configured to translate the rotational motion and energy of the spindle or similar rotary machine into a rotation on an axis comprising the cutting aspects of a cutting tool such as the spherical cutting tool. Such axis may be a different from the drill unit/s spindle axis, where rotation of the cutting aspects of the tool may be about an axis different from the drill unit/s spindle axis by at least 1 degree and less than 180 degrees.

Said second axis may be adjustable based on a predefined angular position within the workpiece. The system of the invention having a second axis off a gear box may further have a second spherical cutting tool comprising a second sphere cutter, a second drilling, reaming, end-milling or similar cutting tool, and a second roller burnisher set that is diametrically opposed to the first set.

The tool and/or system of the invention may be used in the first method for cutting at least a portion of a spherical surface on an internal or external surface of a workpiece, the method comprising: orienting a first spindle in a predetermined locked position; affixing the spherical cutting tool to the spindle; positioning the tool adjacent to a surface of the workpiece to make contact with a surface for at least a portion of the spherical surface to be machined; contacting said surface with the spherical cutting tool; and machining the work piece with the spherical cutting tool having an end-cutting element and roller burnisher.

In either method, the surface adjacent to which the tool is positioned may be an inner surface or outer surface.

Alternatively, an embodiment of the second method of the invention for a spherical cutting tool having more than one set of cutting elements, having a gearbox for rotation of the cutting elements about a second axis, the cutting mechanisms may be positioned adjacent to multiple surfaces of the workpiece that are diametrically opposed. The set of tools may be moved in a first direction to machine one surface using the first tool set, then in a second direction to machine a second surface using the second tool set. Or alternatively the tool may rotate in a fixed position as the workpiece is moved against the cutter accomplishing the cutting action.

When the system of the invention comprises a gearbox at the end of the drive machine that is adjustable, capable of being manipulated to a second geometric shape and position, the methods of the invention may further include the step of manipulating the gearbox to adjust the tool to a position to insert the tool into a workpiece, as well as the step for manipulating the tool about the joint of the system to its first position, the tool may be positioned adjacent to an inner surface, and the spindle and tool may be actuated to contact the surface and machine said surface with the sphere cutter, cutting tool and/or roller burnisher.

In such a method, either before or after machining, while inside a workpiece, the methods of the invention includes steps for manipulating the tool to said second position for movement, the tool may be retracted away from the surface, or out of the inside of the workpiece.

An embodiment of the methods conclude with unloading and storing the cutting tool.

At any point of the methods, there may be a step for selectively positioning the tool of the invention in cutting engagement, or forming engagement in the case of the roller burnisher, with the workpiece, axially moving the cutting end of the tool toward the cutting surface, adjusting the roller burnisher of the spherical cutting tool to act as a stabilizer within a cut hole that was either rough cut using a first drilling operation, or is cut using the drill or other implement at the end of the cutting tool of the invention, opposite the spindle or otherwise at the end of the spherical cutting tool.

In all instances, the cutting step may also include dispersion of coolant or oil to wash or cool the cut surface. In some instances, a second coolant or oil source may be employed to further cool or wash the cutting surface.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The steps of the method of the invention may be completed in the order as described, or may be substantially performed in the order as described.

As such, those skilled in the art will appreciate that the conception upon which this disclosure is based may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

1) An integrated spherical cutting tool comprising:
a sphere cutter, and
a roller burnisher.

2) The integrated spherical cutting tool of claim 1, wherein the sphere cutter further comprises a drive connection, the drive connection configured to connect to a drive machine.

3) The integrated spherical cutting tool of claim 2, further comprising an end-cutting tool.

4) The integrated spherical cutting tool of claim 3, wherein the end-cutting tool is one chosen from the group consisting of a drill, end mill, reamer, dreamer, and drill-mill.

5) The integrated spherical cutting tool of claim 2, wherein the drive connection is one chosen from the group consisting of a triangular drive, square drive, hex drive, star drive, and a slotted drive.

6) The integrated spherical cutting tool of claim 2, wherein the rotary machine is one from the group consisting of a spindle, an arbor drive, a gear drive, and a belt drive.

7) The integrated spherical cutting tool of claim 1, wherein the sphere cutter further comprises at least one cutting insert, and the roller burnisher further comprises a size adjustment mechanism, wherein the size adjustment mechanism is integrated into the sphere cutter.

8) The integrated spherical cutting tool of claim 3, wherein the drive connection is configured at a first end of the integrated spherical cutting tool, wherein the roller burnisher is configured at a second end, opposite of the drive connection, wherein the sphere cutter is configured between the roller burnisher and drive connection, and wherein the cutting tool is configured at the second end.

9) The integrated spherical cutting tool of claim 3, wherein the sphere cutter, the end-cutting tool, and the roller burnisher are coaxial about the axis of the spindle connection.

10) A system for using an integrated spherical cutting tool, the system comprising: an integrated spherical cutting tool having a sphere cutter and a roller burnisher, a first drive machine having an axis of rotation, a first drill machine, an indexer, a fixture configured to hold a workpiece on the indexer, a mechanism for changing tools on the first drive machine, and an integrated spherical cutting tool delivery and retrieval mechanism.

11) The system of claim 10, wherein the sphere cutter is a double sided sphere cutter, and is further configured to cut on opposing ends of the sphere cutter, the system further comprising a first drill machine and a second drill machine, each having a cutting tool, wherein the drill machines are oriented in proximity to the indexer 180 degrees in position to one another about the 360-degree circumference of the indexer, and the system further comprising a gearbox that interfaces with the first drive machine and the integrated spherical cutting tool, such that the gearbox body is stationary with respect to the first drive machine, wherein said gearbox is configured to translate rotational motion and energy of the first drive machine into a rotation on a second axis and to impart rotational motion into the integrated spherical cutting tool.

12) The system of claim 11, wherein the axis is different from the first drive machine axis by at least 1 degree and less than 180 degrees.

13) The system of claim 11, wherein the second axis is configured to be adjustable based on a predefined angular position.

14) The system of claim 11, further comprising a second drive machine and a second integrated spherical cutting tool comprising a second sphere cutting tool, a second end-cutting tool, and a second roller burnisher, wherein the second integrated spherical cutting tool has a drive connection and is attached at the drive connection to the second drive machine, and wherein that assembly is diametrically opposed to the first drive machine about the indexer.

15) The system of claim 10, wherein the integrated spherical cutting tool delivery and retrieval mechanism has at least one joint configured to allow the tool to be manipulated between a transport position and a cutting position, the at least one joint configured to lock the tool in a fixed position.

16) A method of using an integrated spherical cutting tool and system comprising;
mounting a workpiece in an indexer fixture of an integrated spherical cutting tool system;
11
machining a hole in a workpiece;
rotating the indexer a predetermined angular distance;
inserting an integrated spherical cutting tool, the integrated spherical cutting tool having a sphere cutting tool, roller burnisher, and drive connection wherein the roller burnisher is configured on a first end of the integrated spherical cutting tool, the drive connection is configured on a second end of the integrated spherical cutting tool, and the sphere cutting tool is configured in between the roller burnisher and the drive connection;
machining the workpiece with said integrated spherical cutting tool by engaging the roller burnisher of the integrated spherical cutting tool in a previously-machined hole;
withdrawing said integrated spherical cutting tool from the workpiece; and
returning the indexer to a starting position.

17) The method of claim 16 wherein mounting a workpiece in the indexer fixture further comprises mounting the workpiece in between at least two drill machines, and the method further comprising machining at least two holes in the workpiece, rotating the indexer a predetermined angular distance, attaching the integrated spherical cutting tool to an arbor of a first drive machine, advancing the integrated spherical cutting tool attached to said first drive machine into the proximity of the workpiece, positioning the integrated spherical cutting tool in proximity to a workpiece surface, machining the workpiece surface using the integrated spherical cutting tool, retracting the arbor, removing the integrated spherical cutting tool from the first drive machine, and retracting fully the first drive machine and retracting the arbor, rotating the indexer, repeating the process for machining additional geometries on at least a second surface of the workpiece, and concluding the method with removing the workpiece from the system and returning the indexer to its predetermined machine starting position.

18) The method of claim 17 wherein the surface of the workpiece that is machined is an inner surface of the workpiece.

19) The method of claim 17, wherein the surface of the workpiece that is machined is an outer surface of the workpiece.

20) The method of claim 17 further comprising adjusting the roller burnisher of the integrated spherical cutting tool to act as a stabilizer against a surface of a cut hole.

21) The method of claim 17 further comprising manipulating a gearbox to adjust the integrated spherical cutting tool to a position to enable insertion of the integrated spherical cutting tool into a workpiece, manipulating the integrated spherical cutting tool about the joint of the system to a first position, positioning the tool adjacent to an inner surface of the workpiece, actuating the integrated spherical cutting tool and rotary machine to contact the surface, and machining said integrated spherical cutting tool.

22) The integrated spherical cutting tool of claim 1, wherein the roller burnisher comprises rotating spherical balls.
